(19) United States
(12) Patent Application Publication
(10) Pub. No.: US 2015/0298247 A1
(43) Pub. Date: Oct. 22, 2015

(54) METHOD OF MANUFACTURING A METALLIC COMPONENT FROM INDIVIDUAL UNITS ARRANGED IN A SPACE FILLING ARRANGEMENT

(71) Applicant: EUROPEAN SPACE AGENCY, Paris Cedex 15 (FR)

(72) Inventors: Wayne Eric VOICE, Nottingham,Nottinghamshire (GB); David John JARVIS, Voorschoten (NL)

(21) Appl. No.: 14/648,354

(22) PCT Filed: Nov. 30, 2012
(86) PCT No.: PCT/EP2012/074080

§ 371 Date: May 29, 2015

(51) Int. Cl. B23K 20/02; B28B 3/00

(52) U.S. Cl. CPC B23K 20/02; B23K 20/023; B28B 3/00

(57) ABSTRACT

The present invention relates to a method of manufacturing a metallic component 4 from a plurality of individual units 1 which are arranged in a space-filling arrangement in a canister 2. The canister will typically be a separate container, but it may also an endogenous canister obtained by applying laser welding 5 to individual units 1 arranged adjacent to outer surfaces of the arrangement so that these units 1 are joined to form a shell of units 1 which constitute the canister 2. Then heat and either high pressure or vacuum is applied so that at least a majority of the units 1 are diffusion bonded together to form a rigid metallic component 4. Heat and high pressure may be applied by a hot isostatic press 3a, and alternatively heat and vacuum may be applied by using a vacuum furnace 3b.

### CROSS-REFERENCE TO RELATED APPLICATIONS

This application is the U.S. national stage application of International Patent Application No. PCT/EP2012/074080, filed Nov. 30, 2012, which is hereby incorporated by reference.

### FIELD OF THE INVENTION

The present invention relates to a method of manufacturing a metallic component and in particular to a method comprising the step of arranging a plurality of individual units in a space-filling arrangement.

### BACKGROUND OF THE INVENTION

Metallic components can be manufactured by a number of processes including machining, such as CNC milling. A factor often referred to within the aerospace community is the buy-to-fly ratio which is the amount of material that is actually flown in the aerospace component divided by the amount of material purchased by the manufacturer; i.e. a measure of how much material you need to purchase in order to manufacture the final component. For example, a CNC machined part would have a typical fly-to-buy ratio of 1:20. As this is very wasteful and costly, net-shape hot isostatic pressing, also known as HIPping, is a good alternative with much less waste and improved fly-to-buy ratios. This method is e.g. known from EP2275393 and EP1669144. By replacing traditional machining with HIPping it is often possible to save in the order of 80% of material. In HIPping, one would typically start with fine 20-100 micron gas-atomised alloy powders poured into and sealed in a mild-steel canister of the desired component shape and then isostatically press the component to near-net shape using high-pressure hot argon gas within a HIP chamber. This results in atomic diffusion which occurs across the boundaries of the particles fusing the particles together and creating one solid piece. With powder feedstock, the starting density is typically 66%, with the remaining 34% as evacuated voids. These voids pose challenges during compaction due to the shape change and bowing of the outer steel canister. Accurate models of powder compaction and shape change are not widely available, and therefore reverse engineering is difficult at present.

Furthermore, when the method described above is used for the manufacturing of composite materials, it can be difficult to arrange the powder from two different materials in a desired arrangement in the canister. Therefore it is not possible to gain full control of the microstructure of a composite component.

### OBJECT OF THE INVENTION

It is an object of the present invention to provide a method of manufacturing a metallic component with near final shape without the need for difficult modelling.

It is another object of the present invention to provide a method of manufacturing a metallic component by which the fly-to-buy ratio can be significantly improved compared to traditional machining.

It is another object of at least some embodiments of the present invention to provide a method of manufacturing metallic components with higher complexity with respect to geometrical shape and material compositions than what is possible with traditionally used manufacturing methods.

It is another object of some embodiments of the invention to provide a method of manufacturing a metallic component with which controlled complex structures of composite materials can be manufactured even for material compositions that are immiscible with traditional manufacturing methods, such as metal moulding and casting.

It is a further object of the present invention to provide an alternative to the prior art.

### SUMMARY OF THE INVENTION

Thus, the above described object and several other objects are intended to be obtained in a first aspect of the invention by providing a method of manufacturing a metallic component, the method comprising
arranging a plurality of individual units in a space-filling arrangement in a canister,
evacuating and sealing the canister, and
subsequently applying heat and either high pressure or vacuum so that at least a majority of the units are diffusion bonded together to form a rigid metallic component.

By “metallic” is preferably meant that the component consists of or contains metal. Examples of possible material combinations are given below.

By “space-filling” is preferably meant that the units essentially fill the space inside the canister. The feature space-filling is related to the geometrical shape of the units and the fact that they stack in a manner where they abut neighboring units along all side surfaces. It does not exclude that there are some cavities along the walls of the canister due to the side surfaces of the units facing the walls of the canister not being parallel thereto. Furthermore, it does not exclude that small gaps may exist between substantially parallel side surfaces of neighboring units resulting from irregularities in the manufacturing thereof. A space-filling arrangement may e.g. be defined as an arrangement in which there would be no free space between the units, if they had a perfect theoretical shape. A large advantage of the space-filling arrangement is that there would be virtually no deformation of the product shape as the units would typically pack with about 99.5% density. This overcomes the need for shape modeling and furthermore removes the risk of having voids trapped inside the material, as such voids could impose weaknesses in the component.

By “canister” is preferably meant an outer container holding the individual units during manufacturing. The shape resembles but is not necessarily identical to the final shape of the component. This is e.g. the case because a final machining of the outer surfaces of the manufactured component may take place.

The canister is typically evacuated by use of a vent tube in a way that will be well known to a person skilled in the art.

In an alternative embodiment of the invention, the method comprises the following steps:
arranging a plurality of individual units in a space-filling arrangement,
applying laser welding, thermal spray or cold spray to individual units arranged adjacent to outer surfaces of the arrangement so that these units are joined to form a shell of units which constitute an endogenous canister,
evacuating and sealing the canister, and
subsequently applying heat and either high pressure or vacuum so that at least a majority of the units are diffusion bonded together to form a rigid metallic component.

Also for this embodiment, the canister is typically evacuated by use of a vent tube in a way that will be well known to a person skilled in the art.

As can be seen from the above wording, the difference between the two alternatives is related to the canister. By “endogenous” is preferably meant “produced within the system” which in the actual context means that the canister is formed by joining some of the units which have been arranged in the space-filling arrangement. This will preferably take place after all units have been arranged, but it would also be possible to arrange the units in central parts of the arrangement after or at the same time as the joining of the units to obtain the canister takes place.

In some embodiments of the invention, heat and high pressure are applied by hot isostatic pressing, and the method then comprises hermetically sealing the canister and placing the canister in a hot isostatic pressing device at high pressure and high temperature for a predetermined time period in order to consolidate and diffusion-bond the individual units.

In other embodiments of the invention, heat and vacuum are applied by using a vacuum furnace, the method comprising placing the canister in the vacuum furnace for a predetermined time period in order to consolidate and diffusion-bond the individual units.

In both of the two last mentioned types of embodiments, the actual temperature and pressure profiles being used will be material dependent. For a given combination of materials and shapes of both the units and the component to be produced, optimized process parameters may be determined e.g. by experimentation and computer simulations. Such simulations can include the use of known mathematical theory on three-dimensional space-filling of different geometrical shapes. It may also comprise information on the material dependent process parameters that are appropriate to ensure a good diffusion bonding between the individual units.

The shape of at least a majority of the units may selected from the group consisting of cubes, truncated octahedra, rhombic dodecahedra, hexagonal and triangular prisms, gyrobifastigia or combinations thereof. The units used for a component may all have the same shape. Different shapes may also be used, e.g. at the edges to ensure more straight edges of the manufactured component, when units having shapes that do not stack to form straight edges are used.

Hereby it will be possible to obtain as near a final shape as possible before the final machining. This will be particularly important when very expensive materials are used.

At least some of the units may comprise engageable male and female parts so that these units can be joined by mutual engagement as part of the step of arranging the units. Hereby the stability of the arrangement before forming of the diffusion bonds can be improved. This may be particularly useful for the embodiments with an endogenous canister. Another advantage can be that the surface areas along which diffusion bonds are formed can be increased which may result in better mechanical properties. Such engageable male and female parts can be used in combination with any of the shapes mentioned above.

A characteristic length of the units may be from 0.1 to 50 mm such as from 0.1 to 1 mm, 0.5 to 5 mm, or 5 to 50 mm, such as 5 to 10 mm, or 10 to 30 mm, or 30 to 50 mm. By “characteristic length” is preferably meant a dimension which characterizes the shape of the unit; it will typically be the length of an edge of the unit. For units having a shape with different lengths of the edges, the characteristic length may e.g. be taken as the length of the longest edge, or an average length.

As can be seen from the above and as will also be clear from the figures, a manufacturing method according to the present invention will typically result in a mesoscopic structure. I.e. it will relate to structures having typical lengths in the mm length scale and will be between the typical micro- and macro structure of a component.

The units used may be made from one or more of the following types of materials: metal, metal alloy, intermetallics, ceramics, leachable salt or combinations thereof. By “intermetallic” is preferably meant solid phases containing two or more metallic elements, with optionally one or more non-metallic elements, whose crystal structure differs from that of the other constituents.

At least some of the units may be made from metal or metal alloys containing one or more of the following materials: Ti, Al, Mg, Fe, Ni, Cu, Co, Mo, Be, Zr, W, Hf, Nb, Ta, Ag, Au, Pt, Pd, Ir, Sm, Gd, Nd, Si, Zn, and V.

For some embodiments of the invention, at least some of the units are made from ceramic. The remaining units will typically be made from a metal or a metal alloy. The ceramic units may e.g. be made from one or of the following materials: SiC, WC, AlN, BN, ZrO₂, and Al₂O₃.

Some of the units may be made from a leachable material which leachable units are arranged so that they can be removed from the component by leaching after forming of diffusion bonds between the remaining units. They will typically be arranged to form one or more continuous channels extending to a surface of the component so that the leached material can be removed while leaving channels in the units. Such channels may e.g. be used for guiding cooling or heating fluid through the component during use thereof. Leachable units may also be used to obtain a foamed component, if it is desired to obtain a lightweight and/or insulating material.

The leachable material may e.g. be a salt which is soluble in water, such as NaCl. It may alternatively be a material which is soluble in caustic or acidic solutions, such as aluminium or iron. The actual material for the leachable units should preferably be chosen so that the liquid used to leach the leachable units does not influence the remainder of the units in an undesired way, such as by inducing corrosion thereof.

The units may be produced via selective laser melting, metal-injection moulding or micro-forging. These methods can be used to efficiently mass-produce the units in very high numbers. Metal injection moulding is mainly used for manufacturing of metal and cermet units; cermets are composite materials composed of ceramic and metallic materials. Micro-forging is mainly used for manufacturing of metal units.

In some embodiments of the invention, the materials and mutual arrangements of the units may be predetermined in a way that results in a functionally-graded component being manufactured. A functionally graded material may be characterized by the variation in composition and structure gradually over volume, such as through the thickness, resulting in corresponding changes in the properties of the material. It may e.g. be used to obtain a component with larger stiffness near the surface, possibly in combination with a low density near the centre. Another parameter which it may be relevant to vary across the thickness is the hardness of the material. This may e.g. be relevant if a high resistance against surface impact is obtained by use of a very hard but relatively expensive material at the surface of the component. The use of a functionally graded material instead of just a hard surface layer can e.g. be used to counteract stress concentrations resulting from variation in elastic properties of the materials. Careful design of functionally graded materials can thereby be used to optimize the components for specific functions and applications.

The units may be arranged in the space-filling arrangement by using a robotic pipette system operated by differential air pressure. Hereby a large number of units can be precisely moved and arranged at a time so that the manufacturing time can be kept low. They can e.g. be arranged layer by layer. Alternatively, the units may be arranged by robots mechanically gripping one or more units at a time. This may e.g. be advantageous for very complicated designs.

In embodiments of the invention, where the units are arranged in a non-endogenous canister, the units may be poured into the canister and subsequently vibrated to obtain packing of the units. This may be a faster way of manufacturing especially for shapes that are found to easily pack in a dense and space-filling way. Such a method may be most advantageous for components where possible inner cavities are not considered to be critical.

A non-endogenous canister may e.g. be made from mild steel. This material HIPs well and can easily be removed later.

In any of the embodiments described above, at least one outer surface of the manufactured component may subsequently be machined to obtain a final outer surface. This is typically done to ensure that the desired shape, dimensions, and surface roughness meet the design criteria for the given component.

A second aspect of the invention relates to a component manufactured by any of the methods as described above. Such a component may be used for a variety of purposes in space, aeronautic, defense, road transport, maritime, energy, chemical, nuclear and engineering applications. Examples of possible components are components for thermal protection systems such as parts with built-in cooling channels, refractory composites, components for hot structures, thermal management materials such as heat transfer devices, lightweight foamed material, components for electromagnetic applications, sonic crystals, and components for acoustic damping.

A third aspect of the invention relates to the use of such a component, e.g. in any of the possible application mentioned above.

The first, second and third aspects of the present invention may each be combined. These and other aspects of the invention will be apparent from and elucidated with reference to the embodiments described hereinafter.

### BRIEF DESCRIPTION OF THE FIGURES

The method of manufacturing a metallic component according to the invention will now be described in more detail with regard to the accompanying figures. The figures show one way of implementing the present invention and is not to be construed as being limiting to other possible embodiments falling within the scope of the attached claim set.

FIG. 1 shows schematically the overall steps in a method according to the invention where the units are arranged in a canister one or more at a time.

FIG. 2 shows schematically an alternative method in which the units near outer surfaces are joined to form an endogenous canister.

FIG. 3.a shows schematically some possible shapes of the units and how they look when arranged in a space-filling arrangement. FIG. 3.b is a photo of a possible unit, and FIG. 3.c is a photo of a possible arrangement of units arranged in a space-filling arrangement.

FIG. 4 shows schematically an example of embodiments of the invention having engageable male and female parts so that these units can be joined by mutual engagement.

FIG. 5 shows schematically a cross sectional view of how units made from leachable material can be used to obtain channels inside the component.

FIG. 6 shows schematically a cross sectional view of a functionally graded material.

FIG. 7 shows schematically how a robotic pipette system can be used to arrange the units in a canister.

FIG. 8 shows schematically the overall steps in a method in which the units are poured into a canister and subsequently vibrated into the desired space-filling arrangement.

FIG. 9 shows schematically how the surfaces of the diffusion bonded component can be machined to obtain the final outer surfaces of the component.

### DETAILED DESCRIPTION OF EMBODIMENTS OF THE INVENTION

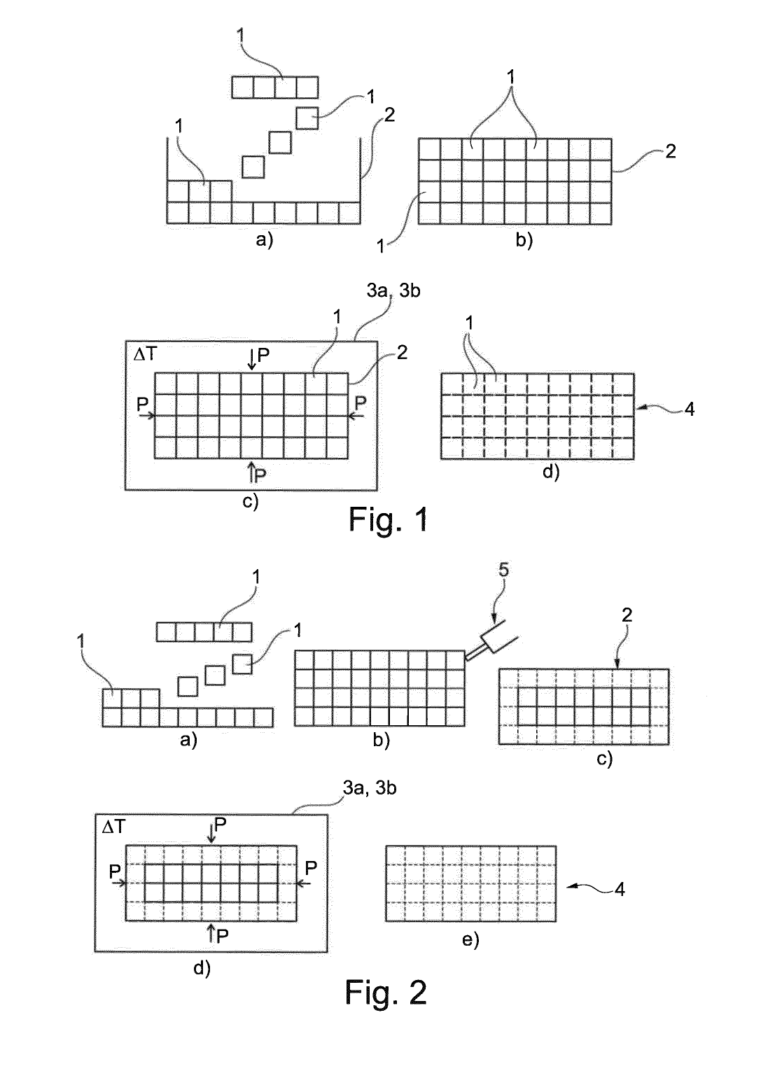

FIG. 1 shows schematically the overall steps in a method according to the invention. The method comprises arranging a plurality of individual units 1 in a space-filling arrangement in a canister 2 as shown in FIG. 1.a. In the figure some of the not yet arranged units 1 are shown separated from each other and others are shown aligned to illustrate that both of these ways of arranging can be used either alone or in combination. Possible ways of doing so will be explained below. FIG. 1.b shows the canister 2 comprising the not yet joined units 1 which are shown in these and the following figures as being cubic for illustrative purposes only. The actual shape used may be any shape that allows the units 1 to be arranged in a space-filling arrangement. The shape of at least a majority of the units 1 may e.g. be selected from the group consisting of cubes, truncated octahedra, rhombic dodecahedra, hexagonal and triangular prisms, gyrobifastigia or combinations thereof.

The canister 2 is then evacuated, typically with a vent tube (not shown), and hermetically sealed; these steps are not shown in the figure, but it will be well known to a person skilled in the art how to perform them. FIG. 1.c shows schematically that heat ΔT and either high pressure or vacuum is subsequently applied so that at least a majority of the units 1 are diffusion bonded together to form a rigid metallic component. The pressure is shown by P which will be an increased number for high pressure process and a lowered number for a vacuum process. The pressures may e.g. be in the range 50-150 MPa. The heat and high pressure may e.g. be applied by hot isostatic pressing in which case the method comprises placing the canister 2 in a hot isostatic pressing device 3a at high pressure and high temperature for a predetermined time period in order to consolidate and diffusion-bond the individual units. Alternatively, the heat and vacuum may be applied by using a vacuum furnace 3b, in which case the method comprises placing the canister 2 in the vacuum furnace 3b for a predetermined time period in order to consolidate and diffusion-bond the individual units 1. The hot isostatic press 3a and the vacuum furnace 3b are shown schematically in the figure as a simple surrounding box. The real design and the functioning thereof will be well known to a person skilled in the art. The resulting component is shown schematically in FIG. 1.d, where the broken lines between the units symbolize that the units are now diffusion bonded together to form a metallic rigid component.

FIG. 2 shows schematically an alternative method which resembles the one described in relation to FIG. 1 except that the canister is formed by the units 1 near outer surfaces of the arrangement. Laser welding 5 is applied to individual units 1 arranged adjacent outer surfaces of the arrangement as shown schematically in FIG. 2.b. Hereby these units 1 are joined to form a shell of units which constitute an endogenous canister 2. The fact that these units 1 are joined before placing the whole arrangement in a hot isostatic press 3a or in a vacuum furnace 3b as described above is illustrated in FIG. 2.c by the interfaces between these outer units 1 being shown with broken lines. The remainder of the method in FIG. 2 resembles the one described in relation to FIG. 1.

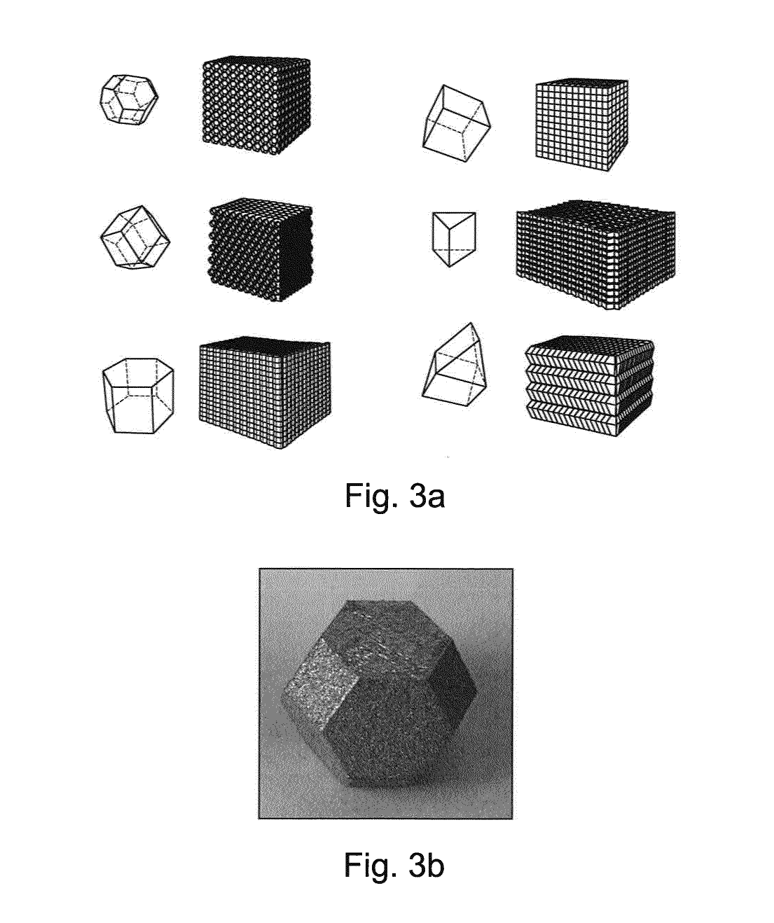

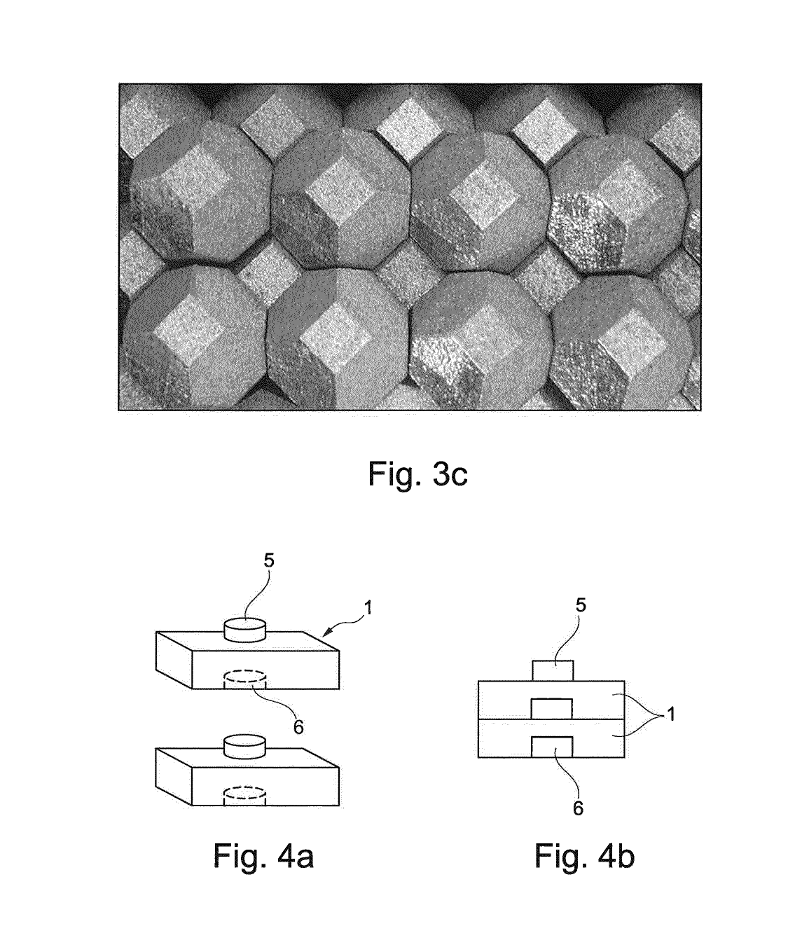

The space-filling arrangement of the individual units 1 may be obtained with various geometrical shapes including the ones shown in FIG. 3.a. The figure also shows corresponding space filling arrangements. The canister is not included in this figure for ease of illustration only. FIG. 3.b is a photos of a units 1 made from nickel super-alloy and manufactured by selective laser melting. It is an example of possible units 1 for use in a method according to the present invention. FIG. 3.c is a photo of units 1 arranged in a space-filling arrangement.

For some embodiments of the invention, all the individual units 1 are made from the same material whereas for others two or more materials are combined. A combination of materials is e.g. advantageous for components 4 having mixed functionality, such as components that should have both a high strength and a high thermal conductivity. The high strength could be obtained by e.g. titanium but that material has undesirably low heat conductivity for many applications. In this case the individual units could be made from two materials, one of them being e.g. copper which has a high thermal conductivity. The copper units 1 could then be arranged in a pattern that provides for heat paths within the component 4.

With the present invention it will be possible to combine the properties of two materials that could not be combined in a controlled manner with other processes. This would e.g. be the case for magnesium and titanium which are immiscible in an ordinary casting process resulting in a two-layered structure, whereas with the present invention it would be possible to manufacture a composite material having a uniform, fine-structured composition having a well-defined inner structure determined by the arrangement of the individual units 1.

In some embodiments of the invention, at least some of the units 1 comprise engageable male 5 and female 6 parts so that these units 1 can be joined by mutual engagement. An example of such engageable units is shown schematically in FIG. 4, where FIG. 4.a shows three dimensional views of two units 1 arranged above each other, and FIG. 4.b shows a cross sectional view of the units 1 after joining. In the figures the male parts 5 are shown as cylindrical protrusions, and the female parts 6 are shown as cylindrical recesses. However, any desired and engageable shape may be used. Each unit 1 may comprise more than one male 5 and female 6 parts, and they may be arranged in any desired pattern, such as near the corners of the unit 1. Such units 1 comprising male 5 and female 6 parts may be used for any the embodiments of the invention, but they may be particularly advantageous for the embodiments as shown in FIG. 2—i.e. the ones where the canister 2 is formed by some of the units 1 as the mutual engagement of the units 1 having male 5 and female 6 parts will ensure a stable arrangement of the units 1 until the endogenous canister 2 has been formed. In the illustrated embodiment, the protrusions 5 and recesses 6 are shown to each be formed on one side of the units 1 only. However, a surface of a unit 1 may comprise both male 5 and female 6 parts, and they may also be formed on more sides of the units 1 provided that they can be arranged in the canister 2 in a convenient way depending on the method used to move them into the canister 2.

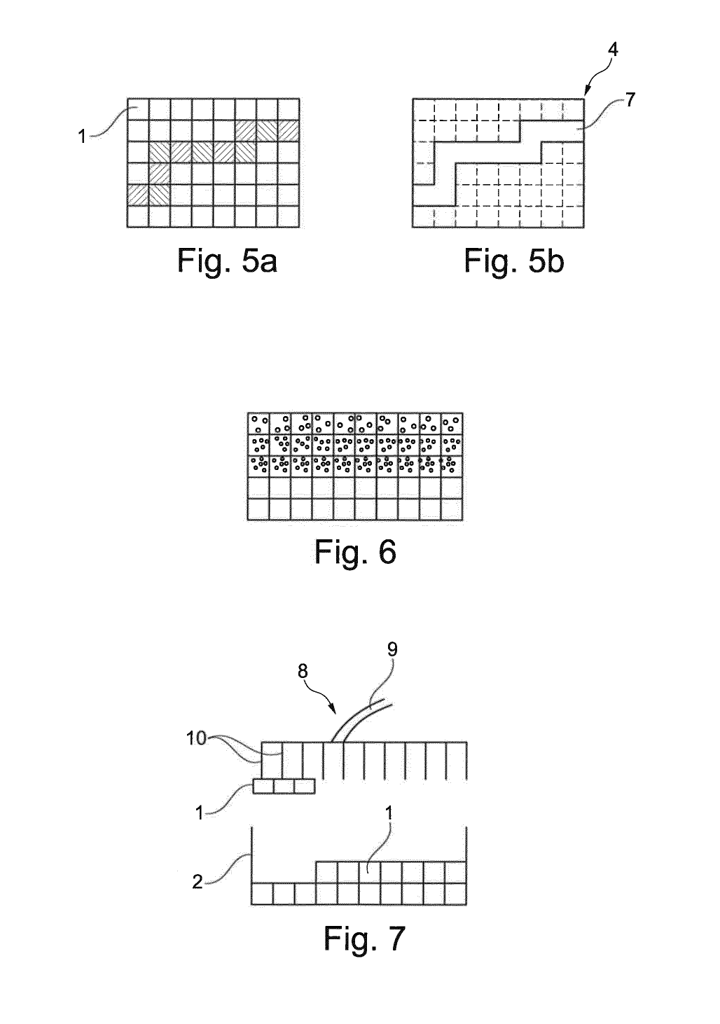

An example of components which may advantageously be produced with the present invention is components comprising internal channels that can be used for e.g. leading cooling or heating fluid there through. Such channels can be difficult to produce by traditionally used methods, such as casting or injection moulding, especially for channels of complex shapes, as it has to be ensured that e.g. inserts or parts of the moulds used during manufacturing can be removed again. With the present invention, internal channels can be obtained by incorporating units 1 made from leachable material which can be removed after the diffusion bonding of the remaining units 1. FIG. 5 shows schematically a cross sectional view of how such units 1 made from a leachable material, shown as hatched, can be used to obtain channels 7 inside the component 4. The figure shows a simplified embodiment with very few leachable units 1 for illustrative purposes only. In practice the relative dimensions and the shape of the channel 7 may be different from the one shown. There may also be more than one channel 7 having the same or different shapes and orientations through the component 4. In order to be able to remove the leachable material, it is necessary that the channel 7, i.e. the uninterrupted “chain” of leachable units 1 forms a contiguous path to the surface of the component 4 so that no leachable units are surrounded by non-leachable units. However, it is not necessary that the one or more channels 7 have the same cross section along the whole length. The leachable units may e.g. be made from salt, such as Sodium Chloride, which is water soluble. Hereby they can be removed by immersion of the component 4 in water after the rest of the units 1 have been joined as described above.

The units may e.g. be mass-produced via selective laser melting, metal-injection moulding or micro-forging. Metal injection moulding is mainly used for manufacturing of metal and cermet units; cermets are composite materials composed of ceramic and metallic materials. Micro-forging is mainly used for manufacturing of metal units. However, any appropriate method used to manufacture the units 1 is considered to be covered by the present invention.

In some embodiments of the invention, the materials and mutual arrangements of the units 1 are predetermined in a way that result in a functionally-graded component being manufactured. An example of how this can be done is shown schematically in FIG. 6. The graded functionality of the component is shown by the units having a gradually varying amount of dots for illustrative purposes only, as the actual parameter varying across the thickness may typically not be visible. It may be any parameter which it is possible and relevant to vary across the thickness, such as the density, the stiffness, and/or the hardness. For some components it will e.g. be relevant to have a high hardness near the surface to avoid damage by impact or wear, whereas a the total weight of the component can be kept low by using a lighter but more soft material further away from the surface. The graduation can then be used to smoothen out e.g. variations in elasticity to avoid stress concentrations during loading of the component.

An example of typical processing parameters for use in the present invention is that for titanium and steel assembled by HIPping, the temperature would typically be 800° C. and the pressure would typically be 100 MPa.

The units 1 can be arranged in the space-filling arrangement by using a robotic pipette system 8 operated by differential air pressure; such a system is shown schematically in FIG. 7. The robotic pipette system 8 comprises a robotic arm 9 holding a number of pipettes 10 each of which is used to transfer an individual unit 1 from a temporary storage (not shown) and onto the desired position in the arrangement in the canister 2. By individual control of the pipettes 10 it is possible to control the number of units 1 being transferred at a time.

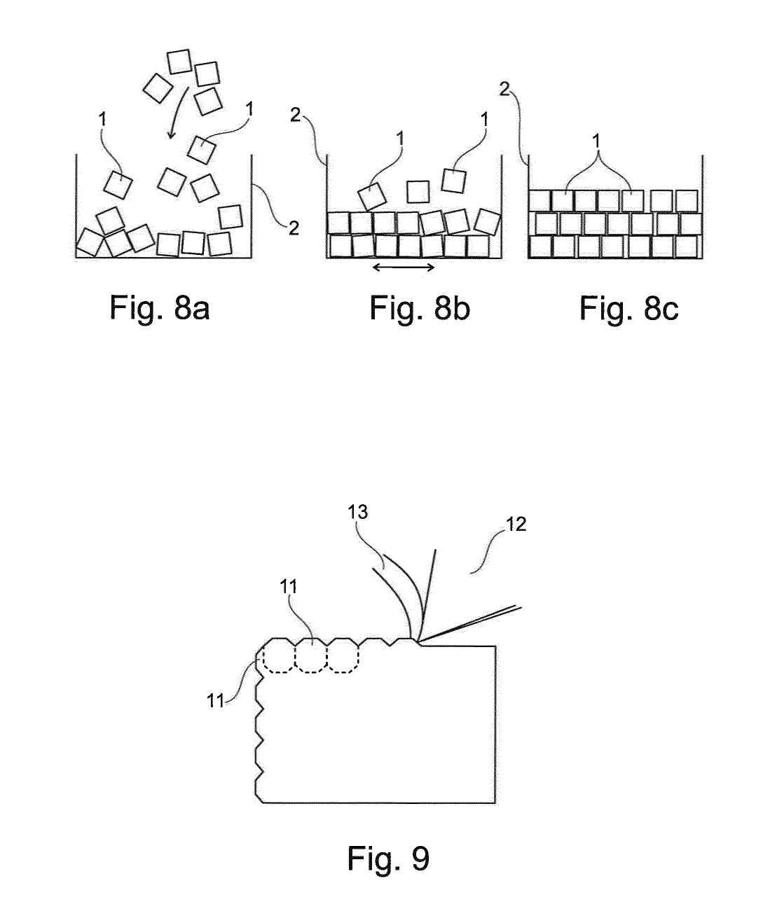

An alternative to arranging the individual units directly into their final position, the units may be poured into the canister 2 and subsequently vibrated to obtain packing of the units. This is shown schematically in FIG. 8, where FIG. 8.a shows the units being poured into the canister, FIG. 8.b shows the vibration V, and FIG. 8.c shows the final arrangement of the units 1. As illustrated in FIG. 8.c, the obtainable final arrangement may not be quite as systematic as when the units 1 are arranged e.g. one layer at a time by use of a robotic pipette system 8 as described above. However, for some shapes of the units 1 and for some applications of the component 4, this will be sufficient. A shape that is considered to be particularly good at “self-arranging” by vibration is truncated octahedra.

After the units 1 have been diffusion bonded together, the component 4 is allowed to cool down, preferably in a controlled manner in order to avoid thermal stresses in the component 4. One or more of the outer surfaces are then preferably machined to obtain a final outer surface having the desired shape, dimensions, and surface roughness meet the design criteria for the given component. For some shapes of the units 1 which pack to arrangements having non-straight edges, this machining also results in a removal of the protruding parts 11. An example of such a machining is shown schematically in FIG. 9 showing the machined surface to the right and at the bottom. The machining is illustrated by the tool 12 resulting in continuous chips 13 which may be the case e.g. in a milling process. Other machining processes such as grinding could also be used alone or in combination therewith.

A method as described above may find use in a number of applications. It may be particularly interesting for components that are to be used in so low numbers that it would be too expensive to use moulding. In such cases the component would normally be made by machining. For many shapes this would mean removing a large amount of material which is disadvantageous both with respect to wasted material and with respect to manufacturing time. Especially for very expensive materials, it is highly disadvantageous to have a high fly-to-buy ratio meaning that there is a large amount of material being removed during manufacturing. An example of one off parts is components used for cladding of nuclear materials.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A method of manufacturing a metallic component, the method comprising
arranging a plurality of individual units in a space-filling arrangement in a canister,
evacuating and sealing the canister, and
subsequently applying heat and either high pressure or vacuum so that at least a majority of the units are diffusion bonded together to form a rigid metallic component.

2. A method of manufacturing a metallic component, the method comprising
arranging a plurality of individual units in a space-filling arrangement,
applying laser welding, thermal spray or cold spray to individual units arranged adjacent to outer surfaces of the arrangement so that these units are joined to form a shell of units which constitute an endogenous canister,
evacuating and sealing the canister, and
subsequently applying heat and either high pressure or vacuum so that at least a majority of the units are diffusion bonded together to form a rigid metallic component.

3. Method according to claim 1, wherein heat and high pressure are applied by hot isostatic pressing, the method comprising hermetically sealing the canister and placing the canister in a hot isostatic pressing device at high pressure and high temperature for a predetermined time period in order to consolidate and diffusion-bond the individual units.

4. Method according to claim 1, wherein heat and vacuum are applied by using a vacuum furnace, the method comprising placing the canister in the vacuum furnace for a predetermined time period in order to consolidate and diffusion-bond the individual units.

5. Method according to claim 1, wherein the shape of at least a majority of the units is selected from the group consisting of cubes, truncated octahedra, rhombic dodecahedra, hexagonal and triangular prisms, gyrobifastigia or combinations thereof.

6. Method according to claim 1, wherein at least some of the units comprise engageable male and female parts so that these units can be joined by mutual engagement.

7. Method according to claim 1, wherein a characteristic length of the units is from 0.1 to 50 mm.

8. Method according to claim 1, wherein the units are made from one or more of the following types of materials: metal, metal alloy, intermetallics, ceramics, leachable salt or combinations thereof.

9. (canceled)

10. (canceled)

11. (canceled)

12. Method according to claim 1, wherein some of the units are made from a leachable material, and these leachable units are arranged so that they can be removed from the component by leaching after forming of diffusion bonds between the remaining units.

13. Method according to claim 1, wherein the units are produced via selective laser melting, metal-injection moulding or micro-forging.

14. Method according to claim 1, wherein the materials and mutual arrangements of the units are predetermined in a way that results in a functionally-graded component being manufactured.

15. Method according to claim 1, wherein the units are arranged in the space-filling arrangement by using a robotic pipette system operated by differential air pressure.

16. Method according to claim 1, wherein the units are poured into the canister and subsequently vibrated to obtain packing of the units.

17. Method according to claim 1 when dependent on claim 1, wherein the canister is made from mild steel.

18. Method according to claim 1, wherein at least one outer surface of the manufactured component is subsequently machined to obtain a final outer surface.

19. Method according to claim 2, wherein heat and high pressure are applied by hot isostatic pressing, the method comprising hermetically sealing the canister and placing the canister in a hot isostatic pressing device at high pressure and high temperature for a predetermined time period in order to consolidate and diffusion-bond the individual units.

20. Method according to claim 2, wherein heat and vacuum are applied by using a vacuum furnace, the method comprising placing the canister in the vacuum furnace for a predetermined time period in order to consolidate and diffusion-bond the individual units.

21. Method according to claim 2, wherein the shape of at least a majority of the units is selected from the group consisting of cubes, truncated octahedra, rhombic dodecahedra, hexagonal and triangular prisms, gyrobifastigia or combinations thereof.

22. Method according to claim 2, wherein at least some of the units comprise engageable male and female parts so that these units can be joined by mutual engagement.

23. Method according to claim 2, wherein a characteristic length of the units is from 0.1 to 50 mm.

24. Method according to claim 2, wherein the units are made from one or more of the following types of materials: metal, metal alloy, intermetallics, ceramics, leachable salt or combinations thereof.

25. Method according to claim 2, wherein some of the units are made from a leachable material, and these leachable units are arranged so that they can be removed from the component by leaching after forming of diffusion bonds between the remaining units.

26. Method according to claim 2, wherein the units are produced via selective laser melting, metal-injection moulding or micro-forging.

27. Method according to claim 2, wherein the materials and mutual arrangements of the units are predetermined in a way that results in a functionally-graded component being manufactured.

28. Method according to claim 2, wherein the units are arranged in the space-filling arrangement by using a robotic pipette system operated by differential air pressure.

29. Method according to claim 2, wherein at least one outer surface of the manufactured component is subsequently machined to obtain a final outer surface.
